(19) United States
(12) Patent Application Publication
(10) Pub. No.: US 2024/0252996 A1
(43) Pub. Date: Aug. 1, 2024

(54) MIXER ASSEMBLY WITH A FIRST AND A SECOND GEARING MECHANISM

(71) Applicant: SEW-EURODRIVE GMBH & CO. KG ABT.ECG, Bruchsal (DE)

(72) Inventor: Gao QIONGHUA, Tianjin (CN)

(73) Assignee: SEW-EURODRIVE GMBH & CO. KG, Bruchsal (DE)

(21) Appl. No.: 18/289,753

(22) PCT Filed: Apr. 19, 2022
(86) PCT No.: PCT/EP2022/025157

§ 371 Date: Nov. 7, 2023

(30) Foreign Application Priority Data
May 13, 2021 (CN) 202110522845.7
Jul. 5, 2021 (DE) 10 2021 003 454.6

(51) Int. Cl. B01F 27/232; B01F 27/053; B01F 27/2122; B01F 35/30

(52) U.S. Cl. CPC B01F 27/2321; B01F 27/053; B01F 27/2122; B01F 2035/351

(57) ABSTRACT

A mixer assembly includes a first gearing mechanism and a second gearing mechanism. The first gearing mechanism has a driven shaft arranged as a hollow shaft, into which an adapter shaft is at least partly inserted and which is rotationally fixed to the driven shaft. The second gearing mechanism has a driven shaft arranged as a hollow shaft. The adapter shaft protrudes through the driven shaft of the second gearing mechanism. A first seal, e.g., a shaft seal ring, is plugged onto the driven shaft such that the seal lip of the seal contacts the driven shaft on a running surface formed on the driven shaft. The running surface is made of a second material and the rest of the driven shaft is made of a first material.

The invention relates to a mixer assembly with a first and a second gearing mechanism.

It is generally known that a gearing mechanism has a driven shaft.

The closest known prior art is a cone mixer and dryer disclosed in DE 20 2009 006 909 U1.

A drive shaft arrangement for a vehicle drive is known from DE 10 2011 054 902 A1.

The object of the invention is therefore to design a compact mixer assembly.

According to the invention, the object is solved in the mixer assembly according to the features given in claim 1.

Important features of the invention of the mixer assembly with a first and a second gearing mechanism are that the first gearing mechanism has a driven shaft designed as a hollow shaft, into which an adapter shaft is at least partly inserted and which is rotationally fixed to the driven shaft,
wherein the second gearing mechanism has a driven shaft designed as a hollow shaft,
wherein the adapter shaft protrudes through the driven shaft of the second gearing mechanism,
wherein a first seal, in particular a shaft seal ring, is plugged onto the driven shaft such that the seal lip of the seal contacts the driven shaft on a running surface formed on the driven shaft,
wherein the running surface is made of a second material and the rest of the driven shaft is made of a first material.

An advantage of this is that the two shafts driving the mixing unit are provided coaxially one inside the other, thus achieving a very compact solution. A further advantage is that the first gearing mechanism can be permanently installed on the second gearing mechanism, since it does not have to be arranged in a co-rotating manner. However, this allows the first gearing mechanism to be attached directly to the second.

In an advantageous embodiment, the adapter shaft is designed as a solid shaft. An advantage of this is that a stable design for the transmission of a high torque can be achieved with a small construction volume.

In an advantageous embodiment, the area covered by the adapter shaft in the axial direction comprises the area covered by the driven shaft of the second gearing mechanism. An advantage of this is that the adapter shaft protrudes completely through the driven shaft, thus achieving a compact design.

In an advantageous embodiment, the adapter shaft is coaxially aligned with the driven shaft of the second gearing mechanism. An advantage of this is that a compact design can be achieved.

In an advantageous embodiment, the running surface is arranged and/or designed on the outside of the driven shaft. An advantage of this is that the sealing towards the mixing unit can be carried out easily and cost-effectively as well as compactly.

In an advantageous embodiment, the coefficient of friction of the material pairing of the material of the seal with the second material is less than the coefficient of friction of the material pairing of the material of the seal with the first material.

An advantage of this is that wear and power dissipation can be reduced, making it possible to achieve a more compact solution with the same performance.

In an advantageous embodiment, the second material causes less wear on the seal than would be caused on the seal if the second material were replaced by the first material, particularly given otherwise unchanged geometric properties of the driven shaft and the seal and given the same speed. An advantage of this is that a longer service life can be achieved.

In an advantageous embodiment, the power dissipation of the seal is less than when the second material is replaced with the first material. An advantage of this is that a more compact design is possible with the same drive power.

In an advantageous embodiment, a second shaft seal ring is plugged onto the adapter shaft, the seal lip of which contacts a second running surface of the driven shaft,
wherein the second running surface is arranged on the hollow inner side and/or inner wall of the driven shaft designed as a hollow shaft,
wherein the second running surface is formed from the second material and the rest of the driven shaft is formed from the first material, particularly excluding the first running surface formed from the second material. An advantage of this is that the driven shaft has a running surface area made of the second material on its inner side and on its outer side, respectively, and the rest of the driven shaft is formed from the first material. The second material is applied by welding and then machined, in particular by circular turning or circular grinding. Machining on the inside is performed as internal circular turning or internal circular grinding.

In an advantageous embodiment, a housing part of the first gearing mechanism is connected to an adapter flange, which is connected to a housing part of the second gearing mechanism. An advantage of this is that direct attachment of the first to the second gearing mechanism is possible, thus achieving a compact solution.

In an advantageous embodiment, the adapter flange has a centering collar which is inserted into a finely machined bore of the housing of the second gearing mechanism, said bore acting as a centering surface. An advantage of this is that the two gearing mechanisms and their shafts can be precisely aligned with each other.

In an advantageous embodiment, the first material is different from the second material,
in particular wherein the first material is a steel and the second material is a steel which has cobalt, chromium and tungsten. An advantage of this is that wear, power dissipation and thus also heat generation can be reduced by simply changing the material in the running surface area of the sealing ring(s), while still allowing a high torque to be transmitted, especially under the impact of axial and lateral forces. Because the stability and rigidity is caused by the first material.

Further advantages result from the subclaims. The invention is not limited to the combination of features of the claims. For the person skilled in the art, further expedient combination possibilities of claims and/or individual claim features and/or features of the description and/or the Figures result, in particular from the object definition and/or the object resulting from a comparison with the prior art.

The invention will now be explained in more detail with the aid of schematic illustrations:

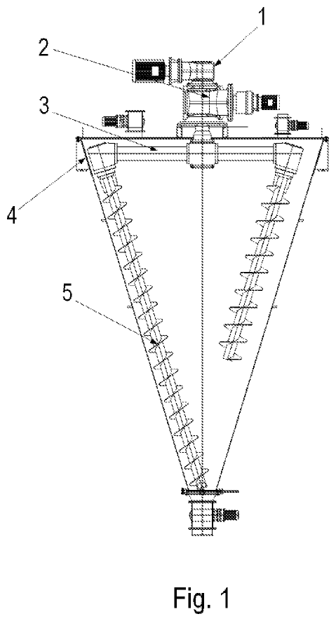

FIG. 1 shows a schematic sketch of a mixer assembly with two driving gearing mechanisms.

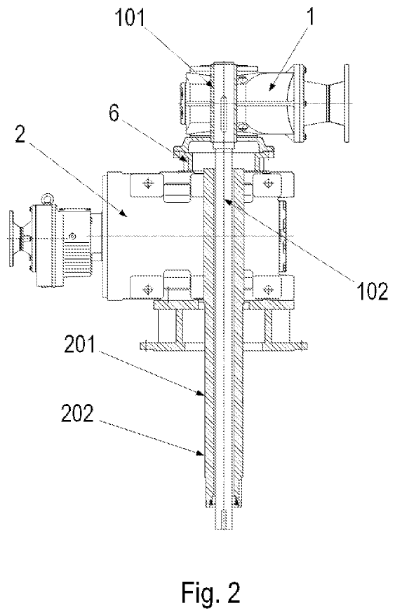

FIG. 2 shows the drive of the mixer assembly in more detail.

As shown in the Figures, a first gearing mechanism 1 is driven by a first motor 1 and a second gearing mechanism 2 is driven by a second motor 2.

The driven shaft of the second gearing mechanism 2 is designed as a hollow shaft 201 and protrudes far from the housing of the second gearing mechanism 2.

The driven shaft of the first gearing mechanism 1 is also designed as a hollow shaft 101, wherein, however, a shaft 102, in particular a solid shaft, is partly inserted into the hollow shaft 101 and is rotationally fixed to the hollow shaft 101.

A frame part 3 is fastened to the hollow shaft 201, which is thus designed to co-rotate with the hollow shaft 201. The frame part 3 extends perpendicular to the shaft 201 on both sides, in particular in a radial direction and opposite thereto.

Through the hollow shaft 201, i.e. through the driven shaft of the second gearing mechanism 2, projects the shaft 102, which is rotationally fixed to the driven shaft of the first gearing mechanism 1. The hollow shaft 201 is arranged coaxially to the shaft 102.

The end of the shaft 102 facing away from the first gearing mechanism 1 drives agitator rods 5 via reversing gearing mechanisms, in particular angular gearing mechanisms 4, in particular ring gearing mechanisms, so that these agitator rods 5 rotate about their own axis and are simultaneously moved along a circular path by the frame part 3 and the second gearing mechanism 2.

The housing of the first gearing mechanism 1 is connected to an adapter flange 6, which is screwed to the housing of the second gearing mechanism 2.

The adapter flange 6 has a centering collar which is inserted into a finely machined bore of the housing of the second gearing mechanism 2, said bore acting as a centering surface, thus enabling precise alignment of the first gearing mechanism 1 with the second gearing mechanism 2.

A seal is accommodated in a housing part of the mixer assembly and seals towards the hollow shaft 201. The seal lip of the seal, which is preferably designed as a shaft seal ring, contacts the hollow shaft 201. At the associated running surface 202 of the hollow shaft 201, the hollow shaft 201, which is otherwise made of a first material, has a second material on its surface and is thus manufactured as a composite part in an axial region which comprises the region covered by the seal in the axial direction, i.e. in the direction of the axis of rotation of the hollow shaft 201.

For this purpose, during the production of the hollow shaft 201, the second material is bonded, in particular welded, to a blank made of the first material. Thereafter, the hollow shaft 201, designed as a composite part in this way, is machined, in particular with circular turning and/or with circular grinding. In this way, a running surface as smooth as possible is available to the seal lip of the seal. The second material is selected in such a way that the friction and thus also the power dissipation of the seal, in particular in the area of the running surface, is reduced. In particular, it is lower compared to the design of a hollow shaft 201 which is geometrically identical but made only of the first material.

The first material is optimized for stiffness and load bearing capacity of the shaft, wherein a steel is preferably used.

The second material preferably has cobalt, chromium and tungsten.

In further embodiment examples according to the invention, a further seal is arranged inside the hollow shaft 201, which further seal is plugged onto the shaft 102, i.e. the adapter shaft, and whose seal lip runs along the inner wall of the hollow shaft 201.

1-12. (canceled)

13. A mixer assembly, comprising:
a first gearing mechanism including a hollow driven shaft;
an adapter shaft at least partially arranged in and rotationally fixed to the hollow driven shaft of the first driving mechanism;
a second gearing mechanism including a hollow driven shaft, the adapter shaft protruding through the driven shaft of the second gearing mechanism; and
a first seal arranged on the driven shaft and including a seal lip in contact with a running surface of the driven shaft of the second gearing mechanism, the running surface being formed of a second material and a remaining portion of the driven shaft of the second gearing mechanism being formed of a first material.

14. The mixer assembly according to claim 13, wherein the first seal includes a shaft seal ring.

15. The mixer assembly according to claim 13, wherein the adapter shaft is arranged as a solid shaft.

16. The mixer assembly according to claim 13, wherein an axial extent of the adapter shaft includes an axial extent of the driven shaft of the second gearing mechanism.

17. The mixer assembly according to claim 13, wherein the adapter shaft is coaxially aligned with the driven shaft of the second gearing mechanism.

18. The mixer assembly according to claim 13, wherein the running surface is arranged on the outside of the driven shaft of the second gearing mechanism.

19. The mixer assembly according to claim 13, wherein a coefficient of friction of a material pairing of a material of the seal with the second material is less than a coefficient of friction of a material pairing of the material of the seal with the first material.

20. The mixer assembly according to claim 13, wherein the second material causes less wear on the seal than would be caused on the seal if the second material were replaced by the first material.

21. The mixer assembly according to claim 13, wherein the second material causes less wear on the seal than would be caused on the seal if the second material were replaced by the first material given otherwise unchanged geometric properties of the driven shaft and the seal and given a same speed.

22. The mixer assembly according to claim 13, wherein a power dissipation of the seal between the seal and the second material is less than a power dissipation of the seal between the second and the first material.

23. The mixer assembly according to claim 13, a second shaft seal ring is arranged on the adapter shaft, a seal lip of the second seal contacting a second running surface of the driven shaft of the second gearing mechanism, the second running surface arranged on a hollow inner side and/or inner wall of the driven shaft of the second gearing mechanism, the second running surface formed of the second material.

24. The mixer assembly according to claim 13, wherein a housing part of the first gearing mechanism is connected to an adapter flange that is connected to a housing part of the second gearing mechanism.

25. The mixer assembly according to claim 24, wherein the adapter flange includes a centering collar inserted into a finely machined bore of the housing of the second gearing mechanism, the bore being arranged as a centering surface.

26. The mixer assembly according to claim 13, wherein the first material is different than the second material.

27. The mixer assembly according to claim 13, wherein the first material is a steel and the second material is a steel that includes cobalt, chromium, and tungsten.

28. The mixer assembly according to claim 27, wherein the first material is different than the second material.

29. A mixer assembly, comprising:
a first gearing mechanism including a hollow driven shaft;
an adapter shaft at least partially arranged in and rotationally fixed to the hollow driven shaft of the first driving mechanism;
a second gearing mechanism including a hollow driven shaft, the adapter shaft protruding through the driven shaft of the second gearing mechanism; and
at least one seal arranged on the driven shaft and including a seal lip in contact with a respective running surface of the driven shaft of the second gearing mechanism, the running surface being formed of a second material and a remaining portion of the driven shaft of the second gearing mechanism being formed of a first material.

30. The mixer assembly according to claim 29, wherein the at least one seal includes a first seal and a second seal, the seal lip of the first seal in contact with a first running surface of the driven shaft of the second gearing mechanism, the seal lip of the second seal in contact with a second running surface of the driven shaft of the second gearing mechanism.

31. A mixer assembly, comprising:
a first gearing mechanism including a hollow driven shaft;
an adapter shaft at least partially arranged in and rotationally fixed to the hollow driven shaft of the first driving mechanism;
a second gearing mechanism including a hollow driven shaft, the adapter shaft protruding through the driven shaft of the second gearing mechanism;
a first seal arranged on the driven shaft and including a seal lip in contact with a first running surface of the driven shaft of the second gearing mechanism, the first running surface being formed of a second material and a remaining portion of the driven shaft of the second gearing mechanism being formed of a first material; and
a second shaft seal ring is arranged on the adapter shaft, a seal lip of the second seal contacting a second running surface of the driven shaft of the second gearing mechanism, the second running surface arranged on a hollow inner side and/or inner wall of the driven shaft of the second gearing mechanism, the second running surface formed of the second material;
wherein a remaining portion of the driven shaft of the second gearing mechanism is formed of a first material.

32. The mixer assembly according to claim 31, wherein the first material is different than the second material.

33. The mixer assembly according to claim 31, wherein the first material is a steel and the second material is a steel that includes cobalt, chromium, and tungsten.

34. The mixer assembly according to claim 33, wherein the first material is different than the second material.
